(19) United States
(12) Patent Application Publication
(10) Pub. No.: US 2008/0120156 A1
(43) Pub. Date: May 22, 2008

(54) APPARATUS AND METHOD FOR INTERNET ADVERTISING COMPENSATION

(76) Inventor: Edward S. Nusbaum, Scottsdale, AZ (US)

Correspondence Address: Wright Law Group, PLLC, Suite 2, 7201 West Oakland,, Chandler, AZ, 85226, US

(21) Appl. No.: 11/943,508

(22) Filed: Nov. 20, 2007

Related U.S. Application Data
(60) Provisional application No. 60/866,535, filed on Nov. 20, 2006.

(51) Int. Cl. G06Q 10/00

(52) U.S. Cl. 705/7

(57) ABSTRACT

The apparatus and methods of the present invention implement an advertising model whereby the Affiliate ID used by an advertising network to normally credit the Affiliate whose site an advertisement is displayed on is instead substituted for the Affiliate ID of a different Affiliate in exchange for physical and tangible compensation (e.g., monetary remuneration) or some other type of non-monetary compensation (e.g., credit, recognition, etc.). In at least one preferred embodiment of the present invention, the advertising-related referral revenue or similar compensation normally paid to a number of disparate Affiliates by one or more advertising networks is aggregated and channeled to a single third party, such as a charity.

### RELATED APPLICATIONS

This application claims the benefit and priority of U.S. Provision Patent Application No. 60/866,535, which application was filed on Nov. 20, 2006, which application is incorporated herein by reference.

### BACKGROUND OF THE INVENTION

1. Field of the Invention

The present invention relates generally to the Internet and more specifically relates to a novel approach for allocating and accounting for referral fees associated with advertising on the Internet.

2. Background Art

The popularization of the Internet in recent years has enabled any properly connected computer to extract various types of information from a web server, and to provide the extracted information to users all over the world easily and quickly. One of the most commonly used Internet applications is the now ubiquitous “search engine.” A search engine allows users to use key words and phrases to search for web pages and other Internet-accessible resources that may be of interest to users. After a user submits a search request that includes the relevant search terms, the search engine service provider identifies web pages and other resources that may be related to those search terms.

The results are displayed in some type of search order, typically based upon one or more proprietary search engine algorithms that have been developed by the search engine provider so as to return the most “relevant” results. The results that are generated in this fashion are commonly referred to as “organic results” and are typically listed in rank order, with the most relevant link being positioned at the top of the page displaying the search results. Since most users rarely venture beyond the first page or two of results, ranking at the top of the list is highly desirable if search engine-generated traffic is desirable.

Most search engine service providers do not charge a usage fee to users of the search engine service. Similarly, there is typically no charge to the providers of web-based resources for including their links in the organic search results generated and displayed by the search engine service provider in response to a user's search request. Rather, the search engine service providers typically obtain revenue by displaying various advertisements in conjunction with the search results. In addition to the advertisements displayed alongside the organic search results, some of the search results themselves may appear as “sponsored” links that are highlighted in the search results listing as the result of an advertising agreement between the operator of the search engine service and the provider of the results displayed by the search engine service provider.

These paid-for search results are typically labeled as “sponsored links” and are generally located at the very top of the page, in the most desirable location, thereby allowing the advertisers to claim a premium spot regardless of their placement in the organic search results. Other forms of advertising such as “sponsored matches,” or “paid-for search results” may also appear alongside the organic search results. An advertiser who wants to place an advertisement for an item along with certain search terms provides the search engine operator with an advertisement and the desired search terms. When a search request is received, the search engine parses the terms used in the search and identifies those advertisements whose sponsors have paid for placement with the terms in the search request. The search engine can either charge for placement of each advertisement displayed along with the search results (i.e., cost per impression or “CPI”) or charge only when a user actually selects a displayed link associated with an advertisement (i.e., pay-per-click or “PPC”).

While the search engine service providers generally make money from their advertisers or sponsors that is just one part of the advertising model that is being implemented on the Internet today. Another piece of the puzzle is the referral component of the advertising model. The referral component allows for the owner and/or operator of a web page to display hyperlink advertisements supplied by various advertisers, directly from the advertiser or indirectly through an intermediary such as a search engine service provider. Whenever a visitor views a website (e.g., SiteA) and views an advertisement on SiteA and then clicks on the related hyperlink, the visitor is transferred to the website for the sponsor of the hyperlinked advertisement (e.g., SiteB). In addition to being transferred to SiteB, an identifier for SiteA is typically associated with the visitor from SiteA, thereby tracking the referral of the visitor from SiteA to SiteB. Many of these referral-based advertising activities have been formalized into “Affiliate” programs.

There are many existing Affiliate programs, systems, and methods used today to encourage one entity (“Affiliate”—a business, website, blog, person, etc.) to refer/send a visitor to a second entity's website (“Merchant”—meaning an entity that may profit by receiving the referral from the Affiliate and that has previously indicated that they will give the Affiliate something of value in return for the referral).

Some of the Affiliate value exchange models currently in use are:

1. Pay Per Impression (PPI)—In this model, the Merchant pays the Affiliate to show an advertisement of some sort to encourage referrals to the Merchant.

2. Pay Per Click (PPC)—In this model, the Merchant pays the Affiliate for each referral made from the Affiliate to the Merchant's site when the visitor to the Affiliate's site “clicks” on the hyperlink for the Merchant's site.

3. Pay Per Action (PPA)—In this model, the Merchant pays the Affiliate for each referral that results in a specified action that happens within a specified period of time, such as the referred filling out a form or purchasing a product from the Merchant within, for example, 24 hours after the referral was initially made. The payment is usually a fixed amount or a fixed percentage of the sale made to the referral from the Affiliate.

All of the existing methods described above may be either done directly between the Merchant and the Affiliate or via an Affiliate network that provides the technology and/or bookkeeping and accounting that is a necessary part of the matching of Merchant and Affiliates. Some examples of existing Affiliate networks include Google's AdSense, Yahoo's Overture, Commission Junction, Linkshare, etc. Those skilled in the art will recognize that these are merely examples of Affiliate networks and that many other similar models exist.

While there are many different methods used for tracking referrals, from the Affiliate website to the Merchant website, the most common method is the use of a pre-assigned ID of the Affiliate and/or the Merchant. As an example, many Affiliates serve up advertisements from Google's advertising network by embedding some programming directions (i.e., javascript code) on one or more of their web pages, such as the following Example 1:

<script type=“text/javascript”><!-
google_ad_client = “pub-1234567890123456”;
google_ad_width = 728;
google_ad_height = 90;
google_ad_format = “728×90_as”;
google_ad_type = “text”;
google_ad_channel = “9876543210”;
//--></script>
<script type=“text/javascript”
src=“http://pagead2.googlesyndication.com/pagead/
show_ads.js”></script>

### EXAMPLE 1

The google_ad_client section of the code shown in Example 1 provides a unique identifier that identifies the Affiliate (“Affiliate ID”) and permits Google to know which Affiliate should get credit for the referral (“Who”). Additionally, the google_ad_channel section of the example shown in Example 1 above also permits Google and the Affiliate to better track from where the Affiliate referral originated (“Where”).

Continuing the Google AdSense example shown in Example 1 above, the javascript code shown also permits Google to display contextually matched advertisements on a web page and then compensate the Affiliate whose google_ad_client ID is embedded in that code for any referrals that are generated from any relevant activity at that web page.

In today's Internet advertising model, a measurable number of websites make revenue simply by making referrals to other websites, and many of those sites also look for ways of receiving referrals from other sites. PPI and PPC advertising models are often used to gain referral traffic to such “middleman” sites—with the “middleman” sites attempting to generate enough referral traffic such that the Affiliate revenue that they gain from facilitating such traffic will result in an effective arbitrage by being greater than the amount they spend to gain that referral traffic.

While the present referral systems and Affiliate programs have been very successful, particularly in generating revenue for Google and other similar advertising networks and/or affiliate service providers, they are not without their drawbacks. For example, the Google AdSense program requires that an individual advertisement publisher (“Publisher”) accumulate a minimum of $100 in their account before they can get paid by Google. Accordingly, many Publishers that do not generate significant amounts of traffic have not yet become eligible to be paid and this money remains under Google's control. While this is a good situation for Google and other similar advertising networks and/or affiliate service providers, it may not always be in the best interests of the Affiliates and the Publishers. This situation, along with the relatively static nature of the existing Affiliate advertising model, provides opportunities for new and innovative approaches to Affiliate advertising programs or collaborative advertising networks.

### SUMMARY OF THE INVENTION

The apparatus and methods of the present invention implement an advertising model whereby the Affiliate ID used by an advertising network to normally credit the Affiliate whose site an advertisement is displayed on is instead substituted for the Affiliate ID of a different Affiliate in exchange for physical and tangible compensation (e.g., monetary remuneration) or some other type of non-monetary compensation (e.g., credit, recognition, etc.). In at least one preferred embodiment of the present invention, the advertising-related referral revenue or similar compensation normally paid to a number of disparate Affiliates by one or more advertising networks is aggregated and channeled to a single third party, such as a charity.

### BRIEF DESCRIPTION OF THE DRAWINGS

The preferred embodiments of the present invention will hereinafter be described in conjunction with the appended wherein like designations denote like elements and:

FIG. 1 is a block diagram of a computer-based system for implementing an alternative Internet advertising compensation system in accordance with a preferred exemplary embodiment of the present invention;

FIG. 2 is a flow chart for a method of implementing an alternative Internet advertising compensation system in accordance with a preferred exemplary embodiment of the present invention;

FIG. 3 is a flow chart for a method used to implement an alternative Internet advertising compensation system in accordance with a preferred exemplary embodiment of the present invention; and

FIG. 4 is a schematic diagram illustrating one possible way of implementing an alternative Internet advertising compensation system in accordance with a preferred exemplary embodiment of the present invention.

### DETAILED DESCRIPTION

The apparatus and methods of the present invention implement an advertising model whereby the Affiliate ID used by an advertising network to normally credit the Affiliate whose site an advertisement is displayed on is instead substituted for the Affiliate ID of a different Affiliate in exchange for physical and tangible compensation (e.g., monetary remuneration) or some other type of non-monetary compensation (e.g., credit, recognition, etc.). In at least one preferred embodiment of the present invention, the advertising-related referral revenue or similar compensation normally paid to a number of disparate Affiliates by one or more advertising networks is aggregated and channeled to a single third party, such as a charity.

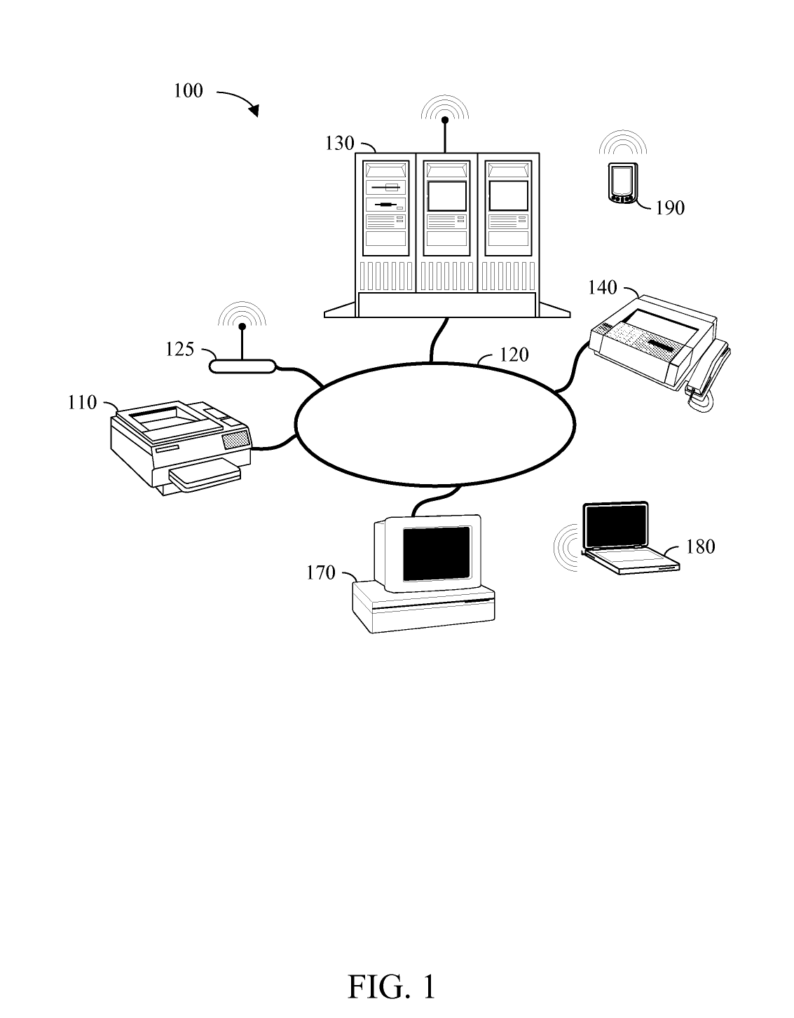

Referring now to FIG. 1, a computer-based system 100 for implementing and accessing an alternative Internet advertising compensation system in accordance with a preferred exemplary embodiment of the present invention comprises: a data server 130; a desktop computer 170; a laptop computer 180, a personal digital assistant (PDA) 190, wireless communication device 125; all communicatively connected or coupled via a network 120. Additionally, an optional printer 110, and an optional fax machine 140 are shown.

Taken together, the components of computer-based system 100 for an alternative Internet advertising compensation system provides a way for a disparate user base, to access one or more components or subsystems of computer-based system 100 as described herein in conjunction with the various preferred embodiments of the present invention. While the present invention will be described in detail by using the example of advertising in the context of the Internet, those skilled in the art will recognize that the methods and techniques described herein have broad applicability to other environments and applications where the use of an alternative Internet advertising compensation system, particularly in the context of tracking referrals and making payments for pre-selected activities is desirable.

Network 120 is any suitable computer communication link or communication mechanism, including a hardwired connection, an internal or external bus, a connection for telephone access via a modem, standard co-axial cable lines, high-speed T1 line, radio, infrared or other wireless communication methodologies (i.e. “Bluetooth,” infrared (IR), etc.), private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, broadcast cable transmission line, Digital Subscriber Line (DSL), ISDN line, or similar public utility-like access link.

In the most preferred embodiments of the present invention, at least a portion of network 120 comprises a standard Internet connection between the various components of computer-based system 100. Network 120 provides for communication between the various components of computer-based system 100 and allows for relevant information to be transmitted from device to device. In this fashion, a user of computer-based system 100 can quickly and easily gain access to the relevant data and information utilized to search, retrieve, and display information from one or more databases as described in conjunction with the preferred embodiments of the present invention. Regardless of physical nature and topology, network 120 serves to logically link the physical components of computer-based system 100 together, regardless of their physical proximity, thereby enabling communication between the components. This is especially important because in the most preferred embodiments of the present invention, data server 130, desktop computer 170, and laptop computer 180 may be geographically remote and/or physically separated from each other. Network 120 may also provide a physical link between the various components of computer-based system 100 that are attached to network 120.

Wireless communication device 125 represents one or more single and/or multi-protocol wireless communication devices that are each capable of capturing, decoding, and transmitting wireless signals. In the most preferred embodiments of the present invention, wireless communication device 125 is a network “hotspot” or similar device capable of communication using some variation of the 802.11x protocol, among others.

Alternatively, wireless communication device 125 could be configured to communicate via RFID, Bluetooth, GSM, etc. The exact protocols supported, along with the specific number and placement of wireless communication devices 125 will be based on the needs or requirements of a specific application. Additionally, logistical factors such as the area of coverage desired, number of devices to be used in the communication process, etc. should be considered. Regardless of the actual number or location where deployed, one or more wireless communication devices 125 will be used to provide access to the search engine components, websites, advertising messages, and other resources and capabilities associated with computer-based system 100.

Data server 130 represents a relatively powerful computer system that is made available to desktop computer 170 and laptop computer 180 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 130. Data server 130 may also provide various additional software components (not shown this FIG.) such as database servers, web servers, firewalls, security software, and the like. The use of these various hardware and software components is well known to those skilled in the art.

Given the relative advances in the state-of-the-art computer systems available today, it is anticipated that functions of data server 130 may be provided by many standard, readily available data servers. Depending on the desired size and relative power required for data server 130, storage area network (SAN) technology may also be deployed in certain preferred embodiments of the present invention. Additionally, various biometric and identification verification devices for creating and verifying digital signatures (i.e., electronic signature processing) may also be included.

Desktop computer 170 may be any type of computer system known to those skilled in the art that is capable of being configured for use with computer-based system 100 as described herein. This includes various levels of desktop computers, tablet computers, pen-based computers and the like. Additionally, handheld and palmtop devices are also specifically included within the description of devices that may be deployed as a desktop computer 170. It should be noted that no specific operating system or hardware platform is excluded and it is anticipated that many different hardware and software platforms may be configured to create desktop computer 170. As previously explained in conjunction with data server 130, various additional hardware components and/or software components (not shown this FIG.) known to those skilled in the art may be used in conjunction with desktop computer 170. It should be noted that in the most preferred embodiments of the present invention, desktop computer 170 may also be linked (via wired or wireless connection) to its own LAN or WAN and has access to its own data server (not shown this FIG.).

Similarly, laptop computer 180 may be any type of relatively lightweight portable computer system known to those skilled in the art that is capable of being configured for use with computer-based system 100 as described herein. This includes tablet computers, pen-based computers and the like. Additionally, handheld and palmtop devices are also specifically included within the description of devices that may be deployed as a laptop computer 180. It should be noted that no specific operating system or hardware platform is excluded and it is anticipated that many different hardware and software platforms may be configured to create laptop computer 180. As previously explained in conjunction with data server 130, various hardware and software components (not shown this FIG.) known to those skilled in the art may be used in conjunction with laptop computer 180. It should also be noted that in the most preferred embodiments of the present invention, laptop computer 180 may also be linked to its own LAN or WAN and has access to its own data server (not shown this FIG.).

PDA 190 is representative of a class of devices that are typically at least somewhat less full-featured and less powerful than computers 170 and 180. This includes, for example, Palm OS devices, Pocket PC devices, and various types of “smart phones” for example. Those skilled in the art will recognize these various devices and others that are suitable for deployment as PDA 190. While somewhat less powerful than computers 170 and 180, PDA 190 is also configured to communicate with data server 130 via network 120 to send and retrieve search engine requests to and from data server 130 and to receive results form data server 130, including Internet resources such as websites and related advertising messages. Given the standard functionality for devices that may be deployed as PDA 190, this communication will typically be a wireless Internet connection, wireless telephone connection, and/or a Bluetooth connection.

In general, the communication between devices associated with data server 130 will be requests for entering date into or retrieving data from one or more databases located on data server 130. A typical example would be for the users of desktop computer 170 and/or laptop computer 180 and/or PDA 190 to perform a search utilizing a search engine interface and database associated with data server 130. In this case, a request to access the search engine and the related search request is sent from desktop computer 170 and/or laptop computer 180 and/or PDA 190 to data server 130. Upon receipt of a valid search request, the search engine associated with data server 130 processes the request to access one or more databases containing the relevant search information, and then retrieves and returns the search results to desktop computer 170 and/or laptop computer 180 and/or PDA 190. In conjunction with the receipt of the search results, it is also common to be provided with various types of Internet-based advertising, typically in conjunction with a webpage, blog, or the like.

It should be noted that while FIG. 1 shows only a single desktop computer 170, a single laptop computer 180, and a single PDA 190, it is anticipated that the most preferred embodiments of the present invention will comprise hundreds and even thousands of computer systems 170, laptop computers 180, and PDAs 190. Each of these will be configured to access data server 130 in an appropriately secure way so as to accomplish the specific objectives of their respective users. For example, the service provider that controls the search engine and databases associated with data server 130 may utilize desktop computer 170 or laptop computer 180 to access data server 130 and create, update, and/or modify a given website, database, etc. Alternatively, a user, interested in finding information on a particular subject, may use desktop computer 170 or laptop computer 180 or PDA 190 to access data server 130 to perform a search and receive various search engine results and Internet-based advertising in response to their search request.

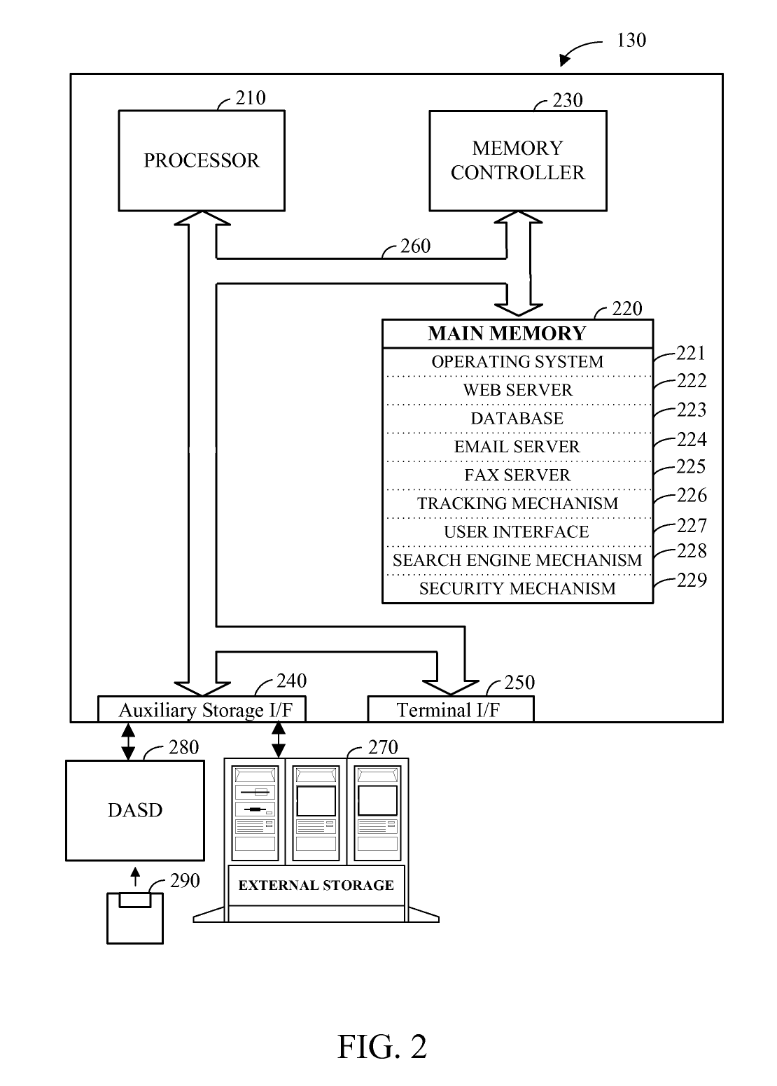

In the most preferred embodiments of the present invention, multiple desktop computers 170 and multiple laptop computers 180 will all be configured to communicate simultaneously with data server 130 and with each other via network 120. In addition, the most preferred embodiments of the present invention include an Application Service Provider (ASP) environment where data server 130 is operated as a clearinghouse in a hosted operation. In this fashion, multiple desktop computers 170 and laptop computers 180 will have access to data server 130 and the databases stored thereon via a global computer network such as the Internet. Data server 130 is further described below in conjunction with FIG. 2 below.

Optional printer 110 and an optional fax machine 140 are standard peripheral devices that may be used for transmitting or outputting paper-based documents, notes, transaction details, reports, etc. in conjunction with the various requests and transactions processed by computer-based system 100. Optional printer 110 and an optional fax machine 140 may be directly connected to network 120 or indirectly connected to network 120 via any or all of desktop computers 170, laptop computers 180, and/or data server 130. Finally, it should be noted that optional printer 110 and optional fax machine 140 are merely representative of the many types of peripherals that may be utilized in conjunction with computer-based system 100. It is anticipated that other similar peripheral devices will be deployed in the various preferred embodiment of the present invention and no such device is excluded by its omission in FIG. 1.

Those skilled in the art will recognize that, except for the enhancements provided by the various preferred embodiments of the present invention, FIG. 1 depicts a somewhat typical “client/server” type communication arrangement where data server 130 is considered to be a server and computers 170 and 180 and PDA 190 can all be considered to be clients of data server 130. Additionally, those skilled in the art will recognize that the functionality of data server 130 may be deployed on either of computers systems 170 and 180 in a more traditional “stand-alone” environment. In either case, the methods of the present invention are designed to minimize the amount of data that must be transferred from a database to the user of computer-based system 100. Additionally, in the case of web applications, no software (other than a standard web browser) may be required to access data server 130 and the associated functionality offered by data server 130.

Referring now to FIG. 2, data server 130 of FIG. 1 in accordance with a preferred embodiment of the present invention represents one of many commercially available computer systems such as a Linux-based computer system, an IBM compatible computer system, or a Macintosh computer system. However, those skilled in the art will appreciate that the methods and apparatus of the present invention apply equally to any computer system, regardless of the specific operating system and regardless of whether the computer system is a traditional “mainframe” computer, a complicated multi-user computing apparatus or a single user device such as a personal computer or workstation.

Data server 130 suitably comprises at least one Central Processing Unit (CPU) or processor 210, a main memory 220, a memory controller 230, an auxiliary storage interface 240, and a terminal interface 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the more salient features of data server 130. Those skilled in the art will recognize the data server 130 may, in fact, comprise multiple disparate computer systems, each configured to accomplish certain tasks and objectives while working in concert with other computer systems to accomplish the methods of the various preferred embodiments of the present invention.

Processor 210 performs computation and control functions of data server 130, and most preferably comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor or CPU. Processor 210 suitably executes one or more software programs contained within main memory 220.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a DVD or CD-ROM drive that may read programs and data from a DVD or CD disk 290.

It is important to note that while the present invention has been (and will continue to be) described in the context of a fully functional computer system with certain application software, those skilled in the art will appreciate that the various software mechanisms of the present invention are capable of being distributed in conjunction with signal bearing media as one or more program products in a variety of forms, and that the various preferred embodiments of the present invention applies equally regardless of the particular type or location of signal bearing media used to actually carry out the distribution. Examples of signal bearing media include: recordable type media such as DVD and CD ROMS disks (e.g., disk 290), and transmission type media such as digital and analog communication links, including wireless communication links.

In the most preferred embodiments of the present invention, various preferred embodiments of the program product may be configured to: create and modify multiple databases; track, update and store information for a plurality of clients, users, and administrators; configure and implement various search and retrieve functions for a multitude of search requests made by users of system 100 of FIG. 1; update and transmit search results to one or more users; track and provide information relative to Internet-based advertising, and provide one or more user interfaces for accomplishing all of these functions. In this fashion, the appropriate entities can utilize the program product to initiate and complete a wide variety of search engine and database-related applications. Similarly, a program product in accordance with one or more preferred embodiments of the present invention can also be configured to perform substantially all of the steps depicted and described in conjunction with the figures below for implementing a fully integrated PFP search engine system.

Memory controller 230, through use of an auxiliary processor (not shown) separate from processor 210, is responsible for moving requested information from main memory 220 and/or through auxiliary storage interface 240 to processor 210. While for the purposes of explanation, memory controller 230 is shown as a separate entity; those skilled in the art understand that, in practice, portions of the function provided by memory controller 230 may actually reside in the circuitry associated with processor 210, main memory 220, and/or auxiliary storage interface 240.

Terminal interface 250 allows users, system administrators and computer programmers to communicate with data server 130, normally through separate workstations or through stand-alone computer systems such as computer systems 170 and computer systems 180 of FIG. 1. Although data server 130 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be used.

In at least one preferred embodiment of the present invention, main memory 220 suitably comprises: an operating system 221; a web server 222; a database 223; an email server 224; a fax server 225; a referral tracking mechanism 226; a user interface 227; a search engine 228; and a security mechanism 229. The term “memory” as used herein refers to any storage location in the virtual memory space of data server 130.

It should be understood that main memory 220 might not necessarily contain all parts of all components shown. For example, portions of operating system 221 may be loaded into an instruction cache (not shown) for processor 210 to execute, while other files may well be stored on magnetic or optical disk storage devices (not shown). In addition, although database 223 is shown to reside in the same memory location as operating system 221, it is to be understood that main memory 220 may consist of multiple disparate memory locations, and even disparate physical locations. It should also be noted that any and all of the individual components shown in main memory 220 might be combined in various forms and distributed as a stand-alone program product. Finally, it should be noted that additional software components, not shown in this figure, might also be included.

For example, most preferred embodiments of the present invention will include a security and/or encryption mechanism 229 for verifying access to the data and information contained in and transmitted by data server 130. Security mechanism 229 may be incorporated into operating system 221 and/or web server 222. Additionally, security mechanism 229 may also provide encryption capabilities for other components of computer-based system 100 of FIG. 1, thereby enhancing the robustness of computer-based system 100. Security mechanism 229 is most preferably configured to protect the integrity and security of the information transmitted via network 120 of FIG. 1.

Once again, depending on the type and quantity of information stored in database 223 and accessed by user interface 227, security mechanism 229 may provide different levels of security and/or encryption for different computer systems 170 and 180 and PDA 190 of FIG. 1. Additionally, the level and type of security measures applied by security mechanism 229 may be determined by the identity of the end-user and/or the nature of a given request and/or response. In some preferred embodiments of the present invention, security mechanism 229 may be contained in or implemented in conjunction with certain hardware components (not shown this FIG.) such as hardware-based firewalls, switches, dongles, and the like.

Operating system 221 includes the software that is used to operate and control data server 130. In general, processor 210 typically executes operating system 221. Operating system 221 may be a single program or, alternatively, a collection of multiple programs that act in concert to perform the functions of an operating system. Any operating system now known to those skilled in the art or later developed may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate and possibly redundant hardware and software systems. This configuration provides additional robustness for system uptime and reliability purposes. Regardless of the specific form of implementation, Web server 222 provides access, including a user interface, to allow individuals and entities to interact with referral tracking mechanism 226, including via network 120 of FIG. 1.

Database 223 is representative of any suitable database known to those skilled in the art. In the most preferred embodiments of the present invention, database 223 is a Structured Query Language (SQL) compatible database file capable of storing information relative to various items that may be of interest to the users of computer-based system 100 of FIG. 1. In the most preferred embodiments of the present invention, database 223 will comprise a collection of information about various users (including Publishers, Affiliates, and the like), accounts, advertiser data, key words and phrases, and links to various informational resources that may be requested by the users of computer-based system 100 of FIG. 1 in conjunction with accessing one or more advertising networks to perform a search.

Those skilled in the art will recognize that other types of information for other types of data that may be used in other applications (e.g., historical, informational, technical, etc.) may be stored and retrieved as well. While database 223 is shown to be residing in main memory 220, it should be noted that database 223 may also be physically stored in a location other than main memory 220. For example, database 223 may be stored on external storage device 270 or DASD 280 and coupled to data server 130 via auxiliary storage I/F 240. Additionally, while shown as a single database 223 and implemented with multiple relational data tables, those skilled in the art will recognize the database 223 may actually comprise a series of related databases, logically linked together by various methodologies. Depending on the specific application and design parameters, database 223 may take many different forms when implemented.

While not required, the most preferred embodiments of data server 130 of FIG. 1 will typically include an email server 224. E-mail server 224 is any email server application capable of being configured and used to send and receive various status messages and updates to data server 130 and between computers 170, 180, and/or PDA 190 of FIG. 1 via email, as may be necessary to enhance the overall process of completing the various transactions described herein. This includes the generation of automated email messages relating to the tracking, reporting, and management of information stored in database 223 as well as informational messages related to user accounts and the status of search results, advertising, and the related revenues for users of computer-based system 100 of FIG. 1.

Optional fax server 225 is any fax server known to those skilled in the art and is configured to receive inbound fax messages and to transmit outbound fax messages. Fax server 225 may format and transmit any data processed by computer-based system 100 of FIG. 1 and make it available for use by any other component of computer-based system 100 of FIG. 1. Additionally, fax server 225 may process the data received and send it directly to web server 222 and make the incoming data available for further processing by computer-based system 100 of FIG. 1, including referral tracking mechanism 226.

Referral tracking mechanism 226 is a software application or mechanism that is used in conjunction with database 223 to track and record information about access to Internet-based advertising and the compensation generated by pre-determined user activities. Referral tracking mechanism 226 is configured to receive information from a variety of external sources and interpret the data to determine the source of and ultimate destination for compensation related to Internet-based advertising.

User interface 227 is a software application or mechanism that is used to provide an interface for users of computer-based system 100 of FIG. 1. By utilizing user interface 227, a user can access and interface with referral tracking mechanism 226 in order to store information in and to retrieve information from database 223. Additionally, advertisers can utilize user interface 227 to place, modify, and cancel referral and Affiliate information for their Internet-based advertising programs and to provide information about their accounts and links or other information related to the results of search requests and to otherwise access the functionality of the various components of computer-based system 100 of FIG. 1. In the most preferred embodiments of the present invention, user interface 227 is a web-browser interface for a web-based application delivered to a user's web browser via web server 222.

Search engine mechanism 228 is a software application or mechanism that correlates the various search engine key words provided by users of system an alternative Internet advertising compensation system and returns results that correspond with the user's request as well as advertisements or information resources presented by the various advertisers that have decided to utilize computer-based system 100 of FIG. 1 for advertising purposes. Search engine mechanism 228 is any search engine service provider such as Google, Yahoo, etc.

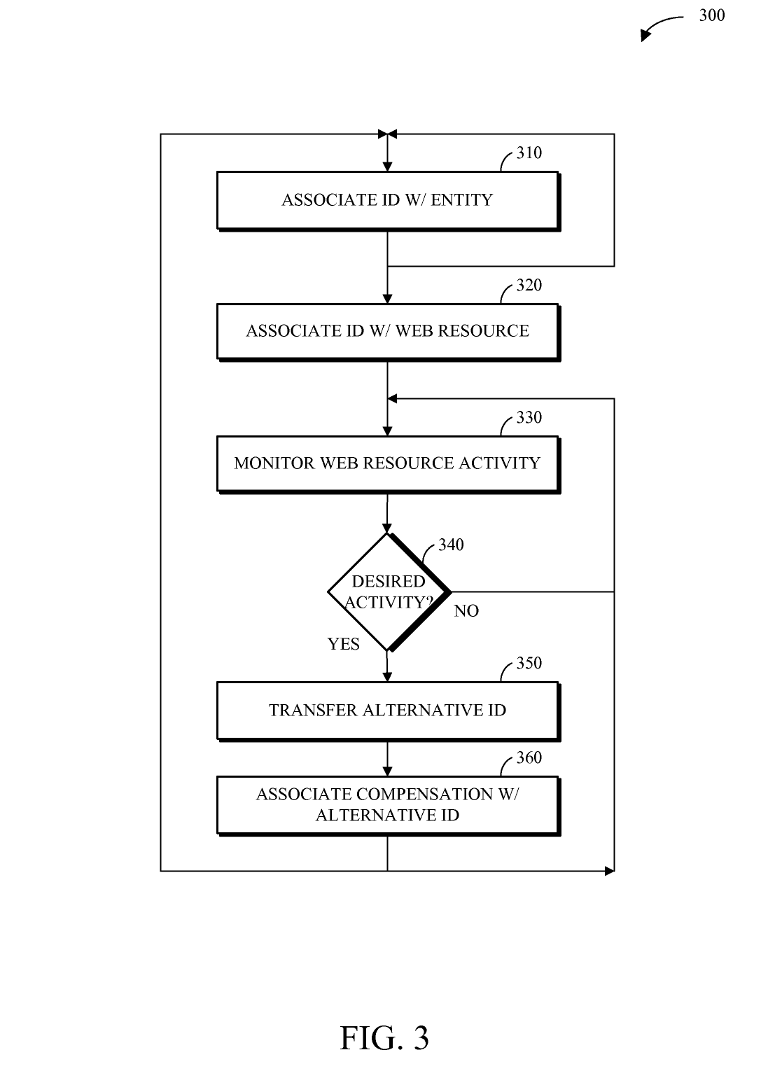

Referring now to FIG. 3, a method 300 for implementing an alternative Internet advertising compensation system in accordance with a preferred embodiment of the present invention is depicted. As shown in FIG. 3, a unique ID is associated with each entity that may be involved in a given transaction (step 310). This will typically be a Publisher ID, Affiliate ID, or the like, depending on the specific application. As shown in FIG. 3, this activity can continue as long as may be necessary to assign a unique ID to each participating entity.

Next, each unique ID is associated with the desired web resource (step 320). A web resource is typically some discrete element associated with a web page. This may be an advertisement supplied by a search engine service provider, a hyperlink to another web page or website, or any similar type of resource for which the web page owner wishes to track activity. It should be noted that in most present implementations of Internet advertising systems, the unique ID associated with each resource is the ID for the owner of the web page or website where the web resource appears. However, in the most preferred embodiments of the present invention, the unique ID associated with at least some of the web resources will identify a different entity.

Next, the activity associated with the various web resources is monitored, typically by an Advertising Network or via an Advertising Network (step 330), to determine whether or not the monitored activity is the desired activity that will trigger some type of compensation. Desired activities can vary, depending on the application, but will typically involve having a visitor to the web page or website click on an advertisement or hyperlink. Once desired activity is detected (step 340=“YES”), then the alternative ID (e.g., a unique ID that is not associated with the owner/operator of the web page or website) affiliated with the identified web resource may be transferred or “referred” to the next destination (step 350). This is the case for the Affiliate Chain Referral process. Additionally, the compensation allocated to the desired activity may be credited or associated with the alternative ID by the advertising network, whether or not the alternative ID is transferred (step 360). Alternatively, if the monitored activity is not a desired activity (step 340=“NO”), then the monitoring of the web resource activity will resume (step 330).

Much advertising is pay-per-click—for example, where the Advertising Network credits the account of the Affiliate who's Affiliate ID is part of the javascript code that displayed the ad that was clicked upon. In those cases there may be instances where the entity that is being credited is actually the same as the entity that is clicking on the displayed ad on a website. The case where the Affiliate is also the user who clicks upon the ad, either by mistake or intentionally, is usually against the Terms of Service of the Advertising Network and may rise to the level of “click fraud” in the eyes of the operator of the Advertising Network. So, at least one preferred embodiment of the present invention will include an additional component in the Affiliate Referral Chain System to prevent or minimize this possibility. For this embodiment, the site that is running advertisements with the Affiliate ID's of Affiliates who may also be users of the site can seek to detect such possible issues and, if they see an Affiliate on the site as a user, can swap the ads to a different Affiliate ID number to protect against the accidental clicking of an ad that contains the Affiliate's own Affiliate ID.

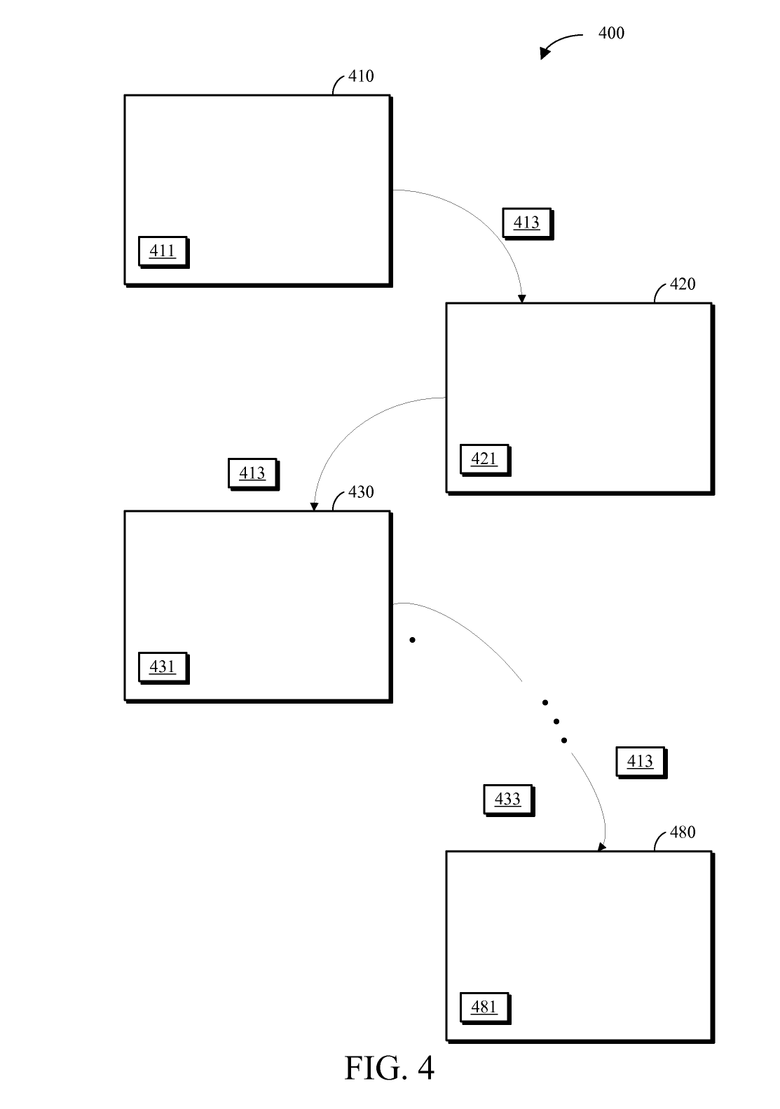

Referring now to FIG. 4, a schematic diagram 400 for one possible implementation of an alternative Internet advertising compensation system in accordance with a preferred embodiment of the present invention is depicted. As shown in FIG. 4, a website 410 has an associated web resource 411. Similarly, website 420 has an associated web resource 421, website 430 has an associated web resource 431, and website 480 has an associated web resource 481. As previously explained, web resources 411, 421, 431, and 481 may be advertisements, hyperlinks, etc. Whenever web resource 411 is selected, the visitor to website 410 that selected web resource 411, along with Publisher ID 413, is transferred to website 420. As previously explained, in the most preferred embodiments of the present invention, Publisher ID 413 does not identify the owner/operator of website 410 and any compensation associated with the selection of web resource 411 may be credited to the entity associated with Publisher ID 413, not the owner/operator of website 410.

Similarly, when the visitor from website 410 arrives at website 420, the visitor from website 410 may select or activate web resource 421. As shown in FIG. 4, this process can continue through multiple layers of referral activity. Depending on the specific implementation and the agreement of the various owners/operators of website 410, 420, 430, and 480, Publisher ID 413 may be transferred, in turn, to each succeeding website. However, it is also possible that at some point along the way, yet another Publisher ID, such as Publisher ID 433, will be substituted for Publisher ID 413. In the case, Publisher ID 433 may refer to the owner/operator of one of the websites that referred the visitor to website 480 or may refer to a third party charity or the like. In any case, any compensation associated with web resource 481 at website 480 will be credited to the entity associated with Publisher ID 433.

The apparatus and methods of the present invention provide for the implementation and operation of a new system for matching referral traffic flow and compensation in the most prevalent forms of Internet advertising in use today. If the “middleman” site (the site which seeks to get referrals from other sites so as to make money by then making referrals to other sites), either directly and/or through a facilitating Affiliate network, were to compensate referrers to the “middleman” site with the ability to have the referrer's Affiliate ID be associated with referrals made onward from the “middleman” site to other sites, then it becomes a form of PPA (where the referrer is only compensated when a specific action occurs for the Merchant, in this case the “middleman” site).

The compensation for a referral to the middleman site is not limited to the traditional model of monetary compensation. While certain preferred embodiments of the present invention may be implemented and deployed to provide monetary compensation related to advertising referrals, other types of compensation are also contemplated. For example, an alternate form of compensation is to have the referrer's Affiliate ID appear for X % of impressions of Y inventory for Z period of time.

Using this example, SiteA refers a visitor to SiteB (the “Middleman Site”). SiteB would compensate SiteA for the referral by associating Affiliate ID's of SiteA in such things as the Google AdSense javascript displayed on SiteB's web pages, so that any resulting referrals would result in SiteA getting the credit (and related financial compensation, if any) for that referral.

The variable X % could mean, for example, that SiteA's Affiliate ID would be included in the Google AdSense javascript on 0 to 100% of SiteB's pages that display AdSense ads for Z period of time (example: 24 hours). If X %=75%, one method of accomplishing that would be to have SiteA's publisher code on the first three pages that have AdSense javascript on them that are visited by the referred visitor, and then one page without, whereupon the cycle would repeat.

The Y inventory variable indicates that SiteB may have many different Affiliate referrer programs to send referrals to other sites (examples: AdSense and Commission Junction and/or different sections of each on any given page), thereby creating an “Affiliate Referral Chain Program” and SiteB may choose to make only some of these available.

So, as an a example of this preferred embodiment of the present invention, where SiteB participates in both Google AdSense and Commission Junction Affiliate Programs to generate revenue by making referrals to other sites, SiteB may decide to offer to compensate a site (SiteA) that refers traffic to them (SiteB) by including SiteA's Affiliate ID on 100% of Google AdSense and 0% of Commission Junction on SiteB to the visitor referred to SiteB by SiteA for a certain period of time (e.g., 24 hours) after the referral is initially made.

To further simplify this specific example of a preferred embodiment, the example above means that by making the referral to SiteB, SiteA is compensated when that referral to SiteB is then referred to yet another site through Google AdSense (which is running on SiteB's site with SiteA's Affiliate ID for pages visited by the referred).

In the same example, SiteB would lose any AdSense revenue that would have resulted from that referral for the first 24 hours (which would go into SiteA's Google AdSense account instead), but keeps any AdSense referral revenue after that 24 hours and also keeps 100% of any Commission Junction or other revenue associated with the initial referral.

This essentially establishes an Affiliate Referral Chain System where the Affiliate that makes the initial referral is only compensated when an additional referral that meets certain conditions or criteria is also made. Or, in other words, it makes some or all of the Affiliate programs running on SiteB run for the benefit of referring SiteA for Z period of time for any visitors that SiteA refers to SiteB.

Those skilled in the art will recognize that there are a number of limiting factors that can be deployed to adjust or customize the type and level of compensation offered by the various preferred embodiments of the present invention. These factors could be based on length of time, minimum or maximum number of clicks or referrals, percentage of clicks from a particular referring site, or even the total amount or type of compensation to be transferred by the substitution of on ID for another. These various factors may be referred to as a time factor, a quantity factor, a percentage factor, or a compensation factor.

In at least one preferred embodiment of the present invention, a system and method is provided for compensating a first website (SiteA) which makes a referral of a visitor to another website (SiteB) by passing the credit back to SiteA for an additional referral of that same visitor from SiteB to one or more other sites (SiteC, SiteD, SiteE, etc.) made via a referral program during a pre-defined “Session” (which may be defined as any pre-determined period of time, number of pages, percentage of pages, percentage of affiliate referral programs on those pages, etc.).

In addition to the previously mentioned methodologies, those skilled in the art will recognize that there are many additional methods of tracking referrals as a web user from one site to another—such as noting from what site the referred visitor (visitor) came from and/or having the link that the visitor follows specially encoded with a referral ID.

Many referral network systems, such as Google AdSense, use one or more versions of a Publisher ID system to help them identify and track referrals. In most instances, this means that whenever Google Adsense ads are displayed on a website via javascript, embedded in that javascript code will be a Publisher ID code that enables Google to know who to credit for any referral made by a visitor clicking on an advertisement displayed at a first web site that links them through to a second site (as shown in Example 1 above). The Publisher ID is a unique number or code that can provide the advertising network with the means to determine who is responsible for generating the desired results in response to the displayed advertisement. In this fashion, the compensation for generating the activity can be credited and awarded to the appropriate party or entity.

Working through the above Example 1 with Google AdSense will provide the following results. If SiteA makes a referral to SiteB and SiteB uses an Affiliate Referral Chain System to reward/encourage SiteA for making referrals to SiteB, SiteB would include SiteA's Google AdSense Publisher ID in the javascript code to display Google AdSense ads on SiteB for that visitor for that Session so that a referral made though such an ad would be credited to the Google AdSense account of SiteA (instead of SiteB). The google_ad_client section of the code shown in Example 1 above permits Google to know which Affiliate should get credit for the referral (“Who”), so, at least in this instance, the simple substitution of an alternative Affiliate ID for the variable associated with the originating Affiliate (example: pub-1234567890123456) will give credit for any referrals to the alternative Affiliate.

The incentive for SiteA to make referrals in this model is provided by the probability/return that balances the probable return from a visitor for a session on SiteA vs. sending that visitor to SiteB and then the probable return from that visitor for a Session on SiteB. In other words, in Example 1 above, all or part of the Google AdSense inventory on SiteB would be shown to the visitor during their Session using SiteA's Publisher ID number, so SiteB essentially is working on behalf of SiteA and SiteA would benefit from any additional referrals made from SiteB of the visitor that SiteA referred to SiteB.

Therefore, as demonstrated by Example 1, the most preferred embodiments of the present invention provide for the ability to track referrals through multiple layers, i.e., tracking referrals through not just one generation of referral (e.g., from SiteA to SiteB), but two generations of referrals (e.g. from SiteA to SiteB to SiteC) or possibly even more layers of referrals in the case where SiteC also uses an Affiliate Referral Chain System that is configured to facilitate a pass-through of SiteA's referral ID via a referral through SiteB.

Another alternative preferred embodiment of the present invention involves the swapping out referral/Publisher ID numbers for referral links presented to a given referred visitor for a given Session to credit the proper party for the referral depending on the contractual arrangement made between the referring parties. In this fashion, it is possible to very carefully and specifically control the types and quantity of compensation offered for various referrals, with the premiums being allocated for those Sessions and activities that are most desirable.

Those skilled in the art will note that this process could be accomplished on a site-to-site basis (where SiteB recruits and tracks referrer sites like SiteA and swaps out Publisher ID numbers in, for example, the javascript for Google AdSense ads displayed on SiteB); or on a third-party network basis, where a service provider may offer such services as coordinating the publicizing of which sites offer such programs and/or the tracking of Publisher ID's. It is anticipated that at least one preferred embodiment of the present invention will involve providing the technical infrastructure for participating sites to facilitate the process of switching Publisher ID's to make the overall program more attractive for more advertisers as well as Affiliates and Publishers or existing Referral networks such as Google AdSense, all of which could directly offer this as an additional service.

Also, it should be noted that in at least some preferred embodiments of the present invention, the Publisher ID that SiteB displays on behalf of SiteA does not necessarily need to identify or belong to owner and/or operator of SiteA. For example, if SiteA wishes to have any compensation that results from its participation in one or more Affiliate Referral Chain Systems be credited to a third party (for example, CharityA or CauseA or SiteX), they could provide the Publisher ID for that CharityA, CauseA, or SiteX instead of their own Publisher ID to SiteB.

It should be noted that this preferred embodiment of the present invention is not just applicable to this specific example of an Affiliate Referral Chain System and it may also be applied to just SiteA alone, even if it does not participate in an Affiliate Referral Chain System. In this example, SiteA could include the Publisher ID of CauseA in the javascript for the Google AdSense shown on SiteA instead of the Publisher ID established for SiteA. This would result in any referral revenue for the Google AdSense program would be credited and paid into the account of CauseA instead of that for SiteA. This creates a way for SiteA to donate to CauseA without directly providing any money to CauseA. This could mean a group of like-minded website operators could all include the Publisher ID for CauseA in their Google AdSense javascript and/or have it included when they participate in an Affiliate Referral Chain System. Each website owner/operator may individually earn only small amounts, but given the cumulative participation of enough websites giving such support to CauseA, it may quickly add up. This type of activity may be associated with the creation and maintenance of a readily accessible database for various Publisher IDs or Affiliate IDs, thereby facilitating the aggregation of referral revenue to a single third party.

In at least one preferred embodiment of the present invention, a database of charitable or other worthy third party causes (“Cause” or “Causes”) may be created and one or more of these Causes may be selected to become the recipient of the compensation provided by the advertising activity generated at one or more websites (“Charitable Transfer”). This could be accomplished by using database 223 of FIG. 2. In this fashion, those Affiliates that participate in any of the advertising models discussed herein will be able to identity a Cause as the recipient of the compensation that would otherwise be due and payable to the Affiliate. This will allow third party Causes to receive monetary compensation from referrals not made on their own sites. The reasons for implementing this particular preferred embodiment are set forth below.

As previously mentioned, certain search engine advertising programs require that the compensation reach a certain threshold level prior to any payments being made. For example, the Google AdSense program requires that a Publisher generate a minimum of $100 in their account before they can get paid. There may be literally millions of bloggers with websites that earn small sums (e.g. $10-$15 a year) and none of these Publishers will be eligible to receive any compensation for years from the AdSense program, if ever. However, if each of these bloggers were to substitute the Publisher ID of the same Cause in each of their respective AdSense javascript codes on each of their respective websites (and also perhaps include the Publisher ID for the Cause in a Affiliate Referral Chain System), that Cause would most likely reach the $100 threshold in short order and the Cause and their supporting websites would all gain.

Additionally, there are a significant number of websites that will not participate in the AdSense program because of their aversion to the concept of “advertising” to the visitors at their website. However, a significant number of these current non-participants may re-think their participation in the program if the compensation from the advertising was not simply a payment for a typical advertisement but were instead positioned as a support of their favorite Cause.

In yet another version of this preferred embodiment of the present invention, a website that presently receives substantial amounts of compensation from the AdSense program may view this as a way to help their favorite charities. For example, such a website may decide that, for some period of time, they will substitute the Publisher ID associated with a Cause for their own Publisher ID, thereby diverting the associated compensation for the relevant period of time to the identified Cause.

In the case of creating a database of third party Publisher ID's such as charities or non-profits Causes, it is important to ensure that the Publisher ID for the Cause is correct and is actually controlled by and benefits the appropriate Cause or party. This issue is addressed in the most preferred embodiment of the present invention by asking the Cause create a “proof-page” by putting the Affiliate ID for the Cause (or a live ad which contains the Affiliate ID of the Cause) that they wish to be publicized on a web page on the site of their own domain name. This makes it easy for the database creator and people using the database to at least confirm that the Affiliate ID is controlled by someone who also has access to publish content to the site of the Cause and potentially creates an audit trail within the Cause if someone within the organization with such access was not authorized to do so or was doing so to their own benefit.

In these Charitable Transfer embodiments of the present invention, a database of Publisher ID's for different Causes and the sites that are supporting those Causes (if they wish to be listed) will be included as part of an independent website devoted to this activity. By including the Publisher ID for the Causes in the database, various entities will be able to quickly and easily locate their favorite Cause and, by including the Publisher ID for their desired Cause in their javascript, the Cause will be credited with the compensation for the advertising activity associated with that javascript.

Those skilled in the art will note that while the examples provided herein are described in the context of being implemented using AdSense and javascript, they can easily be implemented via other affiliate/referral programs and direct links. All that is necessary is a means to pass the credit for the referral back to SiteA from SiteB or some other website in a larger referral chain.

In the case of creating a database of third party Publisher ID's such as charities or non-profits Causes, it is important to ensure that the Publisher ID for the Cause is correct and is actually controlled by and benefits the appropriate Cause or party. This issue is addressed in the most preferred embodiment of the present invention by asking the Cause to create a “proof-page” by putting the Affiliate ID for the Cause (or a live ad which contains the Affiliate ID of the Cause) that they wish to be publicized on a web page on the site of their own domain name. This makes it easy for the database creator and people using the database to at least confirm that the Affiliate ID is controlled by someone who also has access to publish content to the site of the Cause and potentially creates an audit trail within the Cause if someone within the organization with such access was not authorized to do so or was doing so to their own benefit.

In summary, the present invention provides an apparatus and method for implementing and deploying alternative affiliate advertising compensation models for use in conjunction with Internet advertisements using search engines services and websites. The ability to accumulate and aggregate fractional advertising payments into a single account will facilitate the more timely payment of advertising related revenue to the Affiliates and Publishers that are using various advertising networks to generate advertising revenue. Additionally, by substituting one Affiliate ID for another various third parties, such as charities and the like, may be the recipients of advertising revenue from multiple parties.

Lastly, it should be appreciated that the illustrated embodiments are preferred exemplary embodiments only, and are not intended to limit the scope, applicability, or configuration of the present invention in any way. Rather, the foregoing detailed description provides those skilled in the art with a convenient road map for implementing a preferred exemplary embodiment of the present invention. Accordingly, it should be understood that various changes may be made in the function and arrangement of elements described in the exemplary preferred embodiments without departing from the spirit and scope of the present invention as set forth in the appended claims.

1. An apparatus comprising:
at least one processor;
at least one memory coupled to said at least one processor;
a database residing in said at least one memory; and
a referral tracking mechanism, said referral tracking mechanism being configured to:
associate a first unique ID with a first participating entity;
associate said first unique ID with at least one resource;
associate a second unique ID with a second participating entity;
monitor said at least one resource to detect at least one occurrence of a pre-determined activity;
identify at least one form of compensation owed to said first entity based on said pre-determined activity and said first unique ID;
substitute said second unique ID for said first ID; and
provide said second participating entity with said at least one form of compensation instead of said first entity.

2. The apparatus of claim 1 wherein said at least one resource is a webpage.

3. The apparatus of claim 1 wherein said pre-determined activity is a user clicking on a hyperlink on a webpage.

4. The apparatus of claim 1 wherein said first unique ID is a publisher ID.

5. The apparatus of claim 1 wherein said first participating entity comprises a plurality of participating entities and said referral tracking mechanism is further configured to:
detect multiple instances of said predetermined activity wherein said multiple instances are attributable to more than one of said plurality of participating entities;
aggregate at least one form of compensation owed to each of said plurality of participating entities, thereby forming an aggregated compensation;
identify a charitable entity; and
provide said charitable entity with said aggregated compensation.

6. The apparatus of claim 1 wherein said at least one resource is a webpage and wherein said pre-determined activity is a user clicking on a hyperlink on a webpage and wherein said first unique ID is a publisher ID.

7. The apparatus of claim 1 further comprising at least one of a web server, an e-mail server, a fax server, and a security system residing in said at least one memory.

8. The apparatus of claim 1 further comprising:
a web server;
an e-mail server;
a fax server; and
a security system residing in said at least one memory.

9. A method comprising the steps of:
associating a first unique ID with a first participating entity;
associating said first unique ID with at least one resource;
associating a second unique ID with a second participating entity;
monitoring said at least one resource to detect at least one occurrence of a pre-determined activity;
identifying at least one form of compensation owed to said first entity based on said pre-determined activity and said first unique ID;
substituting said second unique ID for said first ID; and
providing said second participating entity with said at least one form of compensation instead of said first entity.

10. The method of claim 9 wherein said at least one resource is a webpage.

11. The method of claim 9 wherein said predetermined activity is a user clicking on a hyperlink on a webpage.

12. The method of claim 9 wherein said first unique ID is a publisher ID.

13. The method of claim 9 wherein said first participating entity comprises a plurality of participating entities and said steps of substituting said second unique ID for said first ID;
and providing said second participating entity with said at least one form of compensation instead of said first entity comprise the steps of:
detecting multiple instances of said pre-determined activity wherein said multiple instances are attributable to more than one of said plurality of participating entities;
aggregating at least one form of compensation owed to each of said plurality of participating entities, thereby forming an aggregated compensation;
identifying a charitable entity; and
providing said charitable entity with said aggregated compensation.

14. The method of claim 9 wherein said at least one form of compensation comprises a cash payment.

15. The method of claim 9 wherein said at least one resource is a webpage and wherein said pre-determined activity is a user clicking on a hyperlink on a webpage and wherein said first unique ID is a publisher ID.

16. The method claim 9 wherein said steps of said method comprise the steps of:
storing at least a first Publisher ID and a second Publisher ID in a database, each of said first Publisher ID and said second Publisher ID being associated with a unique publisher;
affiliating at least one resource with said first Publisher ID;
affiliating at least one pre-determined condition with said at least one resource and entering said at least one pre-determined condition in said database;
monitoring said at least one resource for the occurrence of said at least one condition;
parsing said database to locate said predetermined condition;
automatically substituting said second Publisher ID for said first Publisher ID, based on a said pre-determined condition; and
providing at least one form of compensation to said publisher associated with said second Publisher ID.

17. The method of claim 9 wherein said step of substituting said second unique ID for said first ID is limited by at least one of a time factor, a quantity factor, a percentage factor, or a compensation factor.

18. A program product comprising:
a referral tracking mechanism, said referral tracking mechanism being configured to:
associate a first unique ID with a first participating entity;
associate said first unique ID with at least one resource;
associate a second unique ID with a second participating entity;
monitor said at least one resource to detect at least one occurrence of a pre-determined activity;
identify at least one form of compensation owed to said first entity based on said pre-determined activity and said first unique ID;
substitute said second unique ID for said first ID; and
provide said second participating entity with said at least one form of compensation instead of said first entity; and
a signal bearing media bearing said program product.

19. The program product of claim 18 wherein said signal bearing media comprises at least one of recordable media and transmission media.

20. The program product of claim 18 wherein said referral tracking mechanism is further configured to:
detect multiple instances of said pre-determined activity wherein each of said multiple instances are attributable to one or more of a plurality of participating entities;
aggregate at least one form of compensation owed to each of said plurality of participating entities, thereby forming an aggregated compensation;
identify a charitable entity; and
provide said charitable entity with said aggregated compensation.
